(19) United States
(12) Patent Application Publication
(10) Pub. No.: US 2026/0121008 A1
(43) Pub. Date: Apr. 30, 2026

(54) ANALYTICAL INSTRUMENT INLET

(71) Applicant: Thermo Fisher Scientific (Bremen) GmbH, Bremen (DE)

(72) Inventors: Julius REISS, Berlin (DE); Alexander MAKAROV, Bremen (DE); Ralf Günter HARTMER, Hamburg (DE); Mathias GERSMANN, Bremen (DE); Frederik BUSSE, Bremen (DE)

(73) Assignee: Thermo Fisher Scientific (Bremen) GmbH, Bremen (DE)

(21) Appl. No.: 19/369,032

(22) Filed: Oct. 24, 2025

(30) Foreign Application Priority Data
Oct. 25, 2024 (GB) 2415703.4
Jun. 19, 2025 (GB) 2509779.1

(51) Int. Cl. H01J 49/04; H01J 49/00; H01J 49/16

(52) U.S. Cl. CPC H01J 49/0495; H01J 49/0031; H01J 49/165

(57) ABSTRACT

An inlet for an analytical instrument comprises a transfer tube having an upstream end and a downstream end and a deposition region arranged at or adjacent to the upstream end of the transfer tube. The transfer tube is configured to transfer ions together with a gas flow from the upstream end to the downstream end. The transfer tube and the deposition region are configured such that the gas flow experiences at least one turn in the deposition region, whereupon relatively large particles entrained in the gas flow are deposited in the deposition region. The at least one turn in the gas flow is created by: a change in cross-sectional area of the gas flow in the deposition region, a change in diameter of the gas flow in the deposition region, and/or a change in cross-sectional shape of the gas flow in the deposition region.

### CROSS-REFERENCE TO RELATED APPLICATIONS

This application claims priority from United Kingdom patent application no. GB2415703.4, filed Oct. 25, 2024, and United Kingdom patent application no. GB2509779.1, filed Jun. 19, 2025. The entire disclosures of GB2415703.4 and GB2509779.1 are incorporated herein by reference.

### FIELD

The present disclosure relates to the field of mass spectrometry, and specifically to inlets for mass spectrometers.

### BACKGROUND

In mass spectrometry and allied fields, substances are ionised for handling and analysing under reduced pressure or vacuum conditions. The vacuum transfer of ions from an electrospray ionisation (ESI) ion source is commonly done using a capillary-a tube typically of a few centimetres length and a diameter of less than a millimetre (as described, for example, in U.S. Pat. No. 4,977,320). Usually, this capillary is straight and has a circular (or sometimes letterbox-shaped) cross-section. Deposition of material inside the capillary is a common problem which reduces the effectiveness of the mass spectrometer. Material contained in the ESI solvent deposits on the inner and outer surfaces of the capillary over time and eventually blocks it, changing the transfer conditions and obstructing transfer of ions into vacuum. Heating the capillary can improve its robustness, but material deposition from electrosprayed droplets remains a problem that necessitates regular extraction and cleaning of the capillary.

Different approaches to reduce deposition at the atmosphere to vacuum interface exist, such as changing the orientation of the ESI sprayer to be at an angle or off-axis to the inlet capillary or providing a counter gas or curtain gas flow. Further examples include the use of non-straight ion funnels and/or bends in RF ion guides. A common theme is to break the line-of-sight (i.e. to create a bend in the main ion/flow direction) as droplets, due to inertial effects, will not follow the flow as faithfully as ions. For example, EP 2,808,888 describes an approach in which two 90° bends are provided within an ion inlet to break the line-of-sight so that droplets cannot enter the instrument.

These techniques are well established in the field. However, further reduction in deposition and simplification of hardware is always desirable. This is particularly the case, but not exclusively, for smaller and lower-cost systems with smaller pumps, and hence smaller inner diameters of capillaries, where deposition of material can be too fast, thus shortening service intervals to unacceptably short durations.

It is believed that there remains scope for improvements to inlets, such as atmospheric pressure inlets, for analytical instruments.

### SUMMARY

A first aspect provides an inlet, such as an atmospheric pressure inlet, for an analytical instrument, such as a mass spectrometer, the inlet comprising:
a transfer tube having an upstream end and a downstream end, wherein the transfer tube is configured to transfer ions together with a gas flow from the upstream end to the downstream end; and
a deposition region arranged at or adjacent to the upstream end of the transfer tube;
wherein the transfer tube and the deposition region are configured such that the gas flow experiences at least one turn in the deposition region, whereupon relatively large particles entrained in the gas flow are deposited in the deposition region while relatively small particles entrained in the gas flow remain entrained in the gas flow and are transported beyond the deposition region towards the downstream end of the transfer tube.

The at least one turn in the gas flow may be created by: a change in cross-sectional area of the gas flow in the deposition region, a change in diameter of the gas flow in the deposition region, and/or a change in cross-sectional shape of the gas flow in the deposition region. The transfer tube may have a second cross-sectional area, a second inner diameter, and/or a second cross-sectional shape, and the deposition region may have a first cross-sectional area that is different to (e.g. greater than) the second cross-sectional area, a first inner diameter that is different to (e.g. greater than) the second inner diameter, and/or a first cross-sectional shape that is different to the second cross-sectional shape.

Embodiments provide a capillary that is modified to allow more space for contamination at its inlet end, to ensure that contamination is preferentially deposited in this deposition region, to keep the flow conditions similar to previous (proven) designs, and to allow for simple production. Specifically, one or more turns in the gas flow, e.g. due to a change in cross-sectional area, cause relatively large particles to be deposited in the deposition region (e.g. on an inner wall of the deposition region) due to inertial effects, while relatively small particles remain entrained in the gas flow and are transported beyond the deposition region towards the downstream end of the capillary. Thus, embodiments provide a contamination robust capillary by inertia driven dirt separation and deposition.

Unlike existing designs, and counterintuitively, the transfer tube and the deposition region may be configured such that at least one line-of-sight exists between the upstream end of the deposition region and the transfer tube and/or such that the transfer tube and the deposition region are straight tubes directly connected to one another where the central axis of the deposition region is arranged at a small angle (e.g.)≤10° relative to the central axis of the transfer tube. This means that the modification is much simpler and cheaper to produce and can be retrofitted to exiting designs (e.g. by drilling an additional relatively wide hole at the inlet end of a capillary or by adding a cap having a relatively wide hole to the inlet end of a capillary). The design offers high robustness to contamination build-up and thereby prolongs the service intervals of the inlet and the mass spectrometer. Its unexpected functioning can be understood by the fact that, from the perspective of the capillary, most of the gas and droplet intake is off-axis (this may be helped where the ion source sprayer is not exactly on-axis, as this avoids a high droplet concentration on the axis). The off-axis ions undergo a sharp turn when entering the capillary, and a second sharp turn where the capillary cross section is changed (e.g. narrowed). This causes a large fraction of droplets to be separated, even within a line-of-sight geometry. In the same spirit, a geometry with a small angle (≤10°) and/or with a small shift of axis (such that the cross sections overlap) acts in the same way.

The transfer tube may extend generally along an axial direction from the upstream end to the downstream end, and so the ions together with the gas flow may be transported generally (i.e. dominantly) along the axial direction, i.e. such that the streamlines of the gas flow are for the most part parallel or nearly parallel with the axial direction. The gas flow experiences at least one turn in the deposition region, i.e. such that at the or each turn, the streamlines of the gas flow become non-parallel with the axial direction, e.g. such that the gas flow has some velocity component perpendicular to the axial direction.

The gas flow may experience a single turn in the deposition region or multiple turns in the deposition region. The at least one turn is configured such that the effect of the single turn or the combined effect of the multiple turns is that some, most or all relatively large particles entrained in the gas flow are removed from the gas flow and deposited in the deposition region, while some, most or all relatively small particles entrained in the gas flow remain entrained in the gas flow and are transported beyond the deposition region towards the downstream end of the transfer tube.

The relatively large particles may be particles that have diameters greater than or equal to a first particle diameter, and the relatively small particles may be particles that have diameters less than a second particle diameter, wherein the second particle diameter is less than or equal to the first particle diameter. The first and second particle diameters may be equal. In the case of Electrospray Ionisation (ESI), suitable values for first and second particle diameters may be between about 0.1 μm and 5 μm, such as between about 0.5 μm and 2 μm, such as about 1 μm.

The or each turn in the gas flow may be configured such that the Stokes number for particles having the first particle diameter entrained in the gas flow becomes greater than or equal to 0.5, such as greater than or equal to 1, at that turn. The transfer tube and the deposition region may be configured such that the Stokes number for particles having the first particle diameter entrained in the gas flow is less than 1, such as less than 0.5, outside of (e.g. downstream of) the deposition region. For example, the transfer tube and the deposition region may be configured such that the Stokes number for particles having the first particle diameter entrained in the gas flow is less than 1, such as less than 0.5, at all points through the transfer tube and the deposition region except at the or each turn. Thus, relatively large particles entrained in the gas flow may generally remain entrained in the gas flow except at the or each turn, where they may leave the gas flow due to inertia and may thus be deposited in the deposition region, e.g. on an inner wall of the deposition region.

The or each turn in the gas flow can be created in any suitable manner. One or more or each of the turn(s) in the gas flow may be created by: a change (e.g. reduction) in cross-sectional area of the gas flow in the deposition region, a change (e.g. reduction) in diameter of the gas flow in the deposition region, and/or a change in cross-sectional shape of the gas flow in the deposition region.

The transfer tube may be a straight transfer tube having a main (straight) central axis extending from the upstream end to the downstream end, and the deposition region may be a straight tube having a (straight) central axis extending from an upstream end of the deposition region to a downstream end of the deposition region (which means that the transfer tube and the deposition region are straightforward to manufacture). It would, however, be possible for the transfer tube to be a non-straight transfer tube, in which case its central axis would be non-straight. The downstream end of the deposition region may be immediately adjacent to the upstream end of the transfer tube (i.e. there is no separation between the downstream end of the deposition region and the upstream end of the transfer tube), or the upstream end of the deposition region may correspond to the upstream end of the transfer tube.

In some embodiments, the transfer tube and the deposition region are configured such that at least one line-of-sight exists between the upstream end of the deposition region and the transfer tube. For example, at least one line-of-sight may exist between the upstream end of the deposition region and the upstream end of the transfer tube, and/or between the upstream end of the deposition region and a middle region of the transfer tube, and/or between the upstream end of the deposition region and the downstream end of the transfer tube. To achieve this, the transfer tube and the deposition region may be configured such that the main central axis is coaxial with the central axis of the deposition region, or such that the main central axis is parallel to the central axis of the deposition region, but where there is at least some degree of overlap between the cross-sections of the transfer tube and the deposition region.

Additionally or alternatively, where the downstream end of the deposition region is immediately adjacent to the upstream end of the transfer tube, the transfer tube and the deposition region may be configured such that the second central axis is arranged at small angle (e.g. ≤10°, ≤5°, ≤3°, ≤2° or ≤1°) relative to the main central axis. In this case, at least one line-of-sight may exist between the upstream end of the deposition region and the upstream end of the transfer tube (and optionally between the upstream end of the deposition region and a middle of the transfer tube), while there would be no line of sight between the upstream end of the deposition region and the downstream end of the transfer tube, but the turn between the deposition region and the transfer tube would not be sharp enough (by itself) to cause separation of larger droplets (and instead, in accordance with embodiments, the separation of larger droplets is caused by a change in cross-sectional area or shape of the gas flow in the deposition region).

In some embodiments, one or more or each of the turn(s) in the gas flow is created by a change in cross-sectional area of the gas flow in the deposition region (where the cross-sectional area is an area in a plane perpendicular to the axial direction). For example, for one or more or each of the turn(s), the deposition region and/or the transfer tube may have a larger cross-sectional area upstream of that turn compared to downstream of that turn. At that turn, the cross-sectional area may be decreased by any suitable amount, such as by about 1.5, 2, 3, or more times. The change in cross-sectional area at that turn may be substantially instantaneous or suitably sharp to ensure that relatively large particles leave the gas flow due to inertia at that turn. For example, an inner wall of the deposition region at one or more or each of the turn(s) may be arranged in a plane perpendicular to the axial direction or at some small angle (e.g. less than about 40 degrees) relative to the plane perpendicular to the axial direction.

In particular embodiments, a turn is provided at the downstream end of the deposition region by a change in cross-sectional area. That is, the deposition region may have a first cross-sectional area upstream of the turn, and the transfer tube may have a second cross-sectional area downstream of the turn, wherein the first cross-sectional area is greater than the second cross-sectional area. The first cross-sectional area may be about 1.5, 2, 3, or more times greater than the second cross-sectional area. As such, additional space is provided in the deposition region which can allow for build-up of contamination without adversely affecting the gas flow through the transfer tube.

In some embodiments, there may be a single turn created by a change in cross-sectional area, or there may be multiple turns created by multiple changes in cross-sectional area. Where there are multiple changes in cross-sectional area, one or more of these changes should be a decrease in cross-sectional area, and optionally one or more of these changes may be an increase in cross-sectional area. For example, in some embodiments, the deposition region comprises a chamber having a larger cross-sectional area than the parts of the inlet upstream and downstream of the chamber.

In some embodiments, the deposition region may have substantially the same cross-sectional shape as the (rest of the) transfer tube. For example, the deposition region and the (rest of the) transfer tube may both have a circular or letterbox cross-sectional shape. Alternatively, the deposition region may have a different cross-sectional shape to the (rest of the) transfer tube. In these embodiments, it would be possible for a turn in the gas flow to be created or augmented by a change in cross-sectional shape. It would also or instead be possible for one or both of the transfer tube and/or the deposition region to have multiple different cross-sectional shapes and/or smoothly changing cross-sectional shapes along their lengths.

Similarly, the or each turn in the gas flow may be created by a change in diameter of the gas flow in the deposition region (where the diameter is a length in a direction perpendicular to the axial direction). For example, for one or more or each of the turn(s), the deposition region and/or the transfer tube may have a larger inner diameter upstream of that turn compared to downstream of that turn. At that turn, the inner diameter may be decreased by any suitable amount, such as by about 1.5, 2, 3, or more times.

In particular embodiments, a turn is provided at the downstream end of the deposition region by a change in inner diameter. That is, the deposition region may have a first inner diameter upstream of the turn, and the transfer tube may have a second inner diameter downstream of the turn, wherein the first inner diameter is greater than the second inner diameter. The first inner diameter may be about 1.5, 2, 3, or more times greater than the second inner diameter.

There may be a single turn created by a change in inner diameter, or there may be multiple turns created by multiple changes in inner diameter.

In some embodiments, the transfer tube has substantially the same inner diameter at all points along its length and/or the deposition region has the same inner diameter at all points along its length. Alternatively, one or both of the transfer tube and/or the deposition region may have multiple different inner diameters and/or smoothly changing inner diameters along its length.

The deposition region may have any suitable length relative to the length of the transfer tube. In some embodiments, the total length of the transfer tube is about 5, 10, or more times greater than the length of the deposition region.

The deposition region may be part of the transfer tube. For example, the deposition region may be created by drilling a (single) bore hole in the upstream end of the transfer tube. This provides a particularly convenient and low-cost method for manufacturing the inlet.

Alternatively, the deposition region may be formed from a device arranged adjacent to the upstream end of the transfer tube. This may allow increased flexibility in the shape on the deposition region. For example, the deposition region may be formed from a cap which may be attached to the end of the transfer tube. The device may be formed from any suitable number of one or more parts.

According to a further aspect, there is provided an analytical instrument comprising:
an ionisation region;
a fore vacuum chamber; and
the inlet described above, wherein the instrument is configured such that ions generated in the ionisation region can be transported to the fore vacuum chamber via the inlet.

The analytical instrument may be a mass and/or ion mobility spectrometer.

The ionisation region may be maintained at a relatively high pressure, such as at or around atmospheric pressure, i.e. about 1 bar. The fore vacuum chamber may be maintained at a relatively low pressure, such as at between about 0.1 mbar and 10 mbar, e.g. between about 1 mbar and 5 mbar. This pressure difference may drive the gas flow from the upstream end of the transfer tube to the downstream end of the transfer tube.

The instrument may further comprise an ion source arranged in the ionisation region. The ion source can be any suitable type of ion source such as an Electrospray Ionisation (ESI) ion source. The ion source may produce small (sub mm) particles such as droplets and ions.

The relatively large particles may be droplets produced by the ion source that have diameters greater than or equal to the first particle diameter, and the relatively small particles may be ions and droplets produced by the ion source that have diameters less than the second particle diameter. Thus, the transfer tube and the deposition region may be configured such that (most or all) droplets produced by the ion source that have diameters greater than or equal to the first particle diameter are deposited in the deposition region while (most or all) ions and droplets produced by the ion source that have diameters less than the second particle diameter are transported beyond the deposition region towards the downstream end of the transfer tube. At least some, most or all of the ions may be transported to and beyond the downstream end of the transfer tube.

The instrument may further comprise a mass analyser and one or more ion guides arranged in or downstream of the fore vacuum chamber. The one or more ion guides may be configured to transport ions from the downstream end of the transfer tube to or towards the mass analyser. The ions and/or ions derived from the ions (e.g. fragment ions) may be mass analysed by the mass analyser.

According to a further aspect, there is provided a method of operating an analytical instrument that comprises:
an inlet, such as an atmospheric pressure inlet, comprising a transfer tube having an upstream end and a downstream end, and a deposition region arranged at or adjacent to the upstream end of the transfer tube;
the method comprising:
transferring ions together with a gas flow from the upstream end of the transfer tube to the downstream end of the transfer tube, wherein the transfer tube and the deposition region are configured such that the gas flow experiences at least one turn in the deposition region whereupon relatively large particles entrained in the gas flow are deposited in the deposition region while relatively small particles entrained in the gas flow remain entrained in the gas flow and are transported beyond the deposition region towards the downstream end of the transfer tube.

The at least one turn in the gas flow may be created by: a change in cross-sectional area of the gas flow in the deposition region, a change in diameter of the gas flow in the deposition region, and/or a change in cross-sectional shape of the gas flow in the deposition region. The transfer tube may have a second cross-sectional area, a second inner diameter, and/or a second cross-sectional shape, and the deposition region may have a first cross-sectional area that is different to (e.g. greater than) the second cross-sectional area, a first inner diameter that is different to (e.g. greater than) the second inner diameter, and/or a first cross-sectional shape that is different to the second cross-sectional shape.

According to a further aspect, there is provided a method of manufacturing an inlet for an analytical instrument, the method comprising:
providing a transfer tube having an upstream end and a downstream end, wherein the transfer tube is configured to transfer ions together with a gas flow from the upstream end to the downstream end, and wherein the transfer tube has a second cross-sectional area, a second inner diameter, and/or a second cross-sectional shape; and
creating a deposition region at or adjacent to the upstream end of the transfer tube by:
(i) forming a hole in the upstream end of the transfer tube; or
(ii) attaching a device having a hole adjacent to the upstream end of the transfer tube;
wherein the hole has a first cross-sectional area that is different to (e.g. greater than) the second cross-sectional area, a first inner diameter that is different to (e.g. greater than) the second inner diameter, and/or a first cross-sectional shape that is different to the second cross-sectional shape.

The hole may be configured such that a gas flow will experience at least one turn at the downstream end of the hole, whereupon relatively large particles entrained in the gas flow will be deposited in the deposition region while relatively small particles entrained in the gas flow will remain entrained in the gas flow and will be transported beyond the deposition region towards the downstream end of the transfer tube. The hole may be configured such that at least one line-of-sight exists between the upstream end of the hole and the transfer tube and/or such that the central axis of the hole is arranged at a small angle (e.g.)≤10° relative to the central axis of the transfer tube.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

Each of the various aspects described above can, and in embodiments do, include any one or more or each of the optional features described above and elsewhere herein.

### BRIEF DESCRIPTION OF THE DRAWINGS

Various embodiments will now be described in more detail with reference to the accompanying Figures, in which:

FIG. 1A shows schematically a mass spectrometer in accordance with embodiments.

FIG. 1B shows schematically a mass spectrometer in accordance with embodiments.

FIG. 2 shows schematically detail of a mass spectrometer in accordance with embodiments.

FIG. 3 shows a plot of particle response time versus particle diameter for water droplets in air.

FIG. 4A shows a stroboscopic plot of a simulated droplet with a particle response time of zero travelling through a capillary configured in accordance with embodiments.

FIG. 4B shows a stroboscopic plot of a simulated droplet with a non-zero particle response time (τₚ=10⁻⁵ s) travelling through a capillary configured in accordance with embodiments.

FIG. 5 shows a plot of Stokes number as a function of distance (z) along a capillary configured in accordance with embodiments.

FIG. 6A shows schematically a capillary with a section at the inlet end having a reducing inner diameter.

FIG. 6B shows schematically an inlet section of a capillary having an ellipsoidal to round geometry.

FIG. 6C illustrates schematically a capillary with a section at the inlet end having an enlarged inner diameter.

FIG. 7 shows plots of simulated gas velocity as a function of distance (z) along capillaries of various designs.

FIG. 8 shows plots of simulated gas temperature as a function of distance (z) along capillaries of various designs.

FIG. 9 shows plots of simulated gas velocity as a function of radial distance (y) within capillaries of various designs.

FIG. 10 illustrates simulations of droplet travelling through a capillary configured in accordance with embodiments.

FIG. 11 shows plots of calculated transmission rate versus particle response time for capillaries of various designs.

FIG. 12A shows a plot of velocity magnitude of a gas flow through a capillary including a simplified partial blockage.

FIG. 12B shows a plot of velocity magnitude of a gas flow through a capillary configured in accordance with embodiments including a simplified partial blockage.

FIG. 13 shows plots of mass flow rate versus blockage height for a standard capillary and a capillary configured in accordance with embodiments.

FIG. 14A shows a simulated gas velocity profile of the expansion jet in the rough vacuum chamber for a standard capillary.

FIG. 14B shows a simulated gas velocity profile of the expansion jet in the rough vacuum chamber for a capillary configured in accordance with embodiments.

FIG. 15A shows a simulated gas temperature profile of the expansion jet in the rough vacuum chamber for a standard capillary.

FIG. 15B shows a simulated gas temperature profile of the expansion jet in the rough vacuum chamber for a capillary configured in accordance with embodiments.

FIG. 16 shows schematically a cross section of a capillary configured in accordance with embodiments.

FIG. 17 shows plots of measured total ion current versus time for a standard capillary and a capillary configured in accordance with embodiments.

FIG. 18 shows plots of measured fore-vacuum pressure versus time for a standard capillary and a capillary configured in accordance with embodiments.

FIG. 19 shows schematically a cross section of a capillary configured in accordance with an embodiment.

FIG. 20 shows schematically a cross section of a capillary configured in accordance with an embodiment.

FIG. 21 shows schematically a cross section of a capillary configured in accordance with an embodiment.

FIG. 22 shows schematically a cross section of a capillary configured in accordance with an embodiment.

FIG. 23 shows schematically a front view of a capillary configured in accordance with an embodiment.

FIG. 24 shows schematically a front view of a capillary configured in accordance with an embodiment.

FIG. 25 shows schematically a cross section of a capillary configured in accordance with an embodiment.

### DETAILED DESCRIPTION

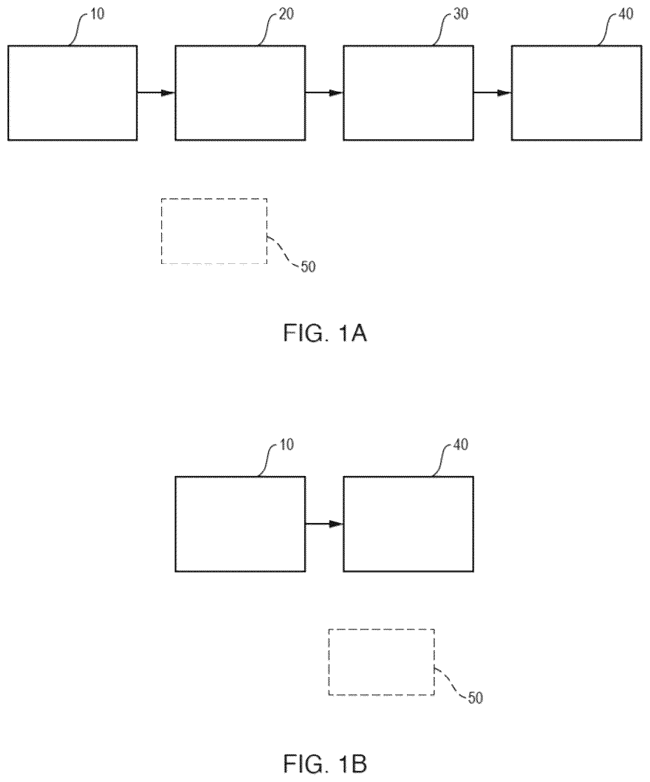

FIG. 1A illustrates schematically an analytical instrument, such as a mass spectrometer, configured in accordance with embodiments. As shown in FIG. 1A, the instrument includes an ion source 10, a mass filter 20, a fragmentation device 30, and a mass analyser 40.

The ion source 10 is configured to generate ions from a sample. The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible.

The mass filter 20 is arranged downstream of the ion source 10 and is configured to receive ions from the ion source 10. The mass filter 20 is configured to filter the received ions according to their mass to charge ratio (m/z). The mass filter 20 may be operable in a transmission mode of operation, whereby most or all ions within a relatively wide m/z window are onwardly transmitted by the mass filter 20, and a filtering mode of operation, whereby only ions within a relatively narrow m/z window are onwardly transmitted by the mass filter 20. The mass filter 20 can be any suitable type of mass filter, such as a quadrupole mass filter.

The fragmentation device 30 is arranged downstream of the mass filter 20 and is configured to receive most or all ions transmitted by the mass filter 20. The fragmentation device 30 may be configured to selectively fragment some or all of the received ions, i.e. so as to produce fragment ions. The fragmentation device 30 may be operable in a fragmentation mode of operation, whereby most or all received ions are fragmented so as to produce fragment ions (which may then be onwardly transmitted from the fragmentation device 30), and a non-fragmentation mode of operation, whereby most or all received ions are onwardly transmitted without being (deliberately) fragmented. The fragmentation device 30 can be any suitable type of fragmentation device, such as for example a collision induced dissociation (CID) fragmentation device, an electron induced dissociation (EID) fragmentation device, a photodissociation fragmentation device, and so on. Numerous other types of fragmentation are possible.

The mass analyser 40 is arranged downstream of the fragmentation device 30 and is configured to receive ions from the fragmentation device 30. Thus, the mass analyser 40 may receive unfragmented precursor ions and/or fragment ions, depending on the mode of operation of the fragmentation device 30. The mass analyser 40 is configured to analyse the received ions so as to determine their mass to charge ratio (m/z) and/or mass, i.e. to produce a mass spectrum of the ions. The mass analyser 40 can be any suitable type of mass analyser, such as an ion trap mass analyser, an electrostatic orbital trap mass analyser (such as an Orbitrap™ FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

FIG. 1B illustrates schematically a simplified analytical instrument, such as a mass spectrometer, configured in accordance with embodiments. As shown in FIG. 1B, the instrument includes an ion source 10 and a mass analyser 40 (and does not include a mass filter nor a fragmentation device). The ion source 10 and mass analyser 40 may each be configured as described above with respect to FIG. 1A, except that the mass analyser 40 may be configured to receive ions directly from the ion source 10 (optionally via one or more transfer stages (not shown)).

It should be noted that FIGS. 1A-1B are merely schematic, and that the instrument can, and in embodiments does, include any number of one or more additional components such as ion optical devices, e.g. configured to transfer ions between the various illustrates components.

As also shown in FIGS. 1A-1B, the instrument is under the control of a control unit 50, such as an appropriately programmed computer, which controls the operation of various components of the instrument and, for example, sets the voltages to be applied to the various components of the instrument. The control unit 50 may also receive and process data from various components including the analyser(s).

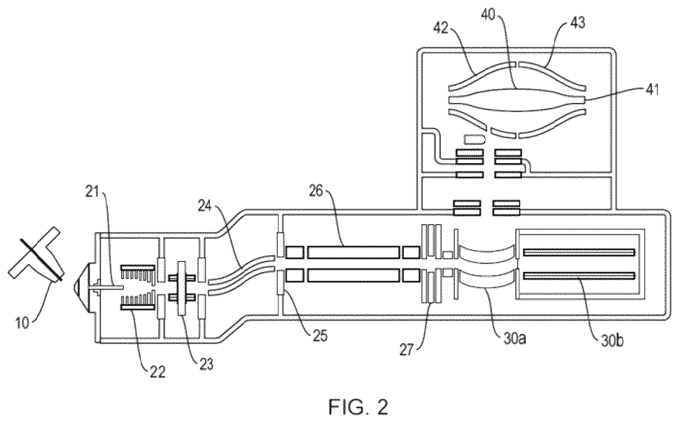

FIG. 2 shows in more detail an example instrument that may be operated in accordance with embodiments. It will be understood that the instrument shown in FIG. 2 is a non-limiting example, and that numerous variations are possible.

As shown in FIG. 2, the instrument's ion source 10 is an electrospray ionisation (ESI) ion source. The instrument includes a vacuum interface, which includes a transfer tube 21, an ion funnel 22, a quadrupole pre-filter ion guide 23, and a “bent flatapole” ion guide 24. The bent flatapole ion guide 24 may be of the design described in U.S. Pat. No. 9,536,722.

The instrument also includes a mass filter in the form of a quadrupole mass filter 26, an ion trap 30a in the form of a curved linear ion trap (“C-Trap”), and a collision cell 30b in the form of an ion routing multipole collision cell (“IRM”). Ions from the ion source 10 can be accumulated in the C-Trap 30a and/or collision cell 30b by opening and closing a gating electrode located in a charge detector assembly 27, which is arranged between the C-Trap 30a and the mass filter 26.

The instrument also includes a mass analyser 40 in the form of an orbital ion trap mass analyser. As shown in FIG. 2, the orbital trap 40 comprises an inner electrode 41 elongated along the orbital trap axis and a split pair of outer electrodes 42, 43 which surround the inner electrode 41 and define therebetween a trapping volume. The pair of outer electrodes 42, 43 also function as detection electrodes to detect an image current induced by the oscillation of the ions in the trapping volume and thereby provide a detected signal. The detected signal can be processed using Fourier transformation to obtain a mass spectrum of ions within the trap.

Once accumulated in the ion trap 30a and/or collision cell 30b, ions can be ejected into the mass analyser 40 for analysis. Ions collected in the ion trap 30a can either be ejected orthogonally to the mass analyser 40 without entering the collision or reaction cell 30b, or the ions can be transmitted axially to the collision or reaction cell 30b for processing before returning the processed ions to the ion trap 30a for subsequent orthogonal ejection to the mass analyser 40. The processing may comprise, for example, fragmenting the ions by collisions with a collision gas and/or a reagent in the collision cell 30b, or further cooling the ions by collisions with a gas at lower energies that do cause the ions to fragment.

As described above, in mass spectrometers the vacuum transfer of ions from the (e.g. electrospray (ESI)) ion source 10 is commonly done by a capillary 21, which is normally a tube of a few centimetres length and a diameter of less than a millimetre. Deposition of material inside this capillary is a common problem that reduces the effectiveness of the instrument. Material contained in the ESI solvent deposits on the inner and outer surfaces of the capillary 21 over time and eventually blocks it, changing the transfer conditions and obstructing transfer of ions into vacuum. Particularly, but not exclusively, for smaller instruments with smaller pumps, and hence smaller inner diameters of the capillary 21, deposition of material can be too fast, thus shortening service intervals to unacceptably short durations.

Embodiments are directed to the design of a transfer capillary which is more robust to dirt deposition, keeps the flow properties in the mass spectrometer as unchanged as possible (most importantly the mass flow rate), requires as little modification as possible to the instrument, and is cheap to produce.

The design of such a transfer capillary with robustness to dirt deposition was divided into two aspects: the design should provide more space for dirt deposition in a deposition region and should ensure that dirt is deposited in this region.

### Droplets Basic Considerations

Unwanted particles (i.e. dirt) are considered to consist mainly of droplets from the electrospray ion source. Due to the droplet fission process, droplets of various sizes are present. Typically, the droplets range in size from 1 μm to 100 μm. Smaller droplets evaporate quickly, while bigger droplets are not created with typical ESI settings.

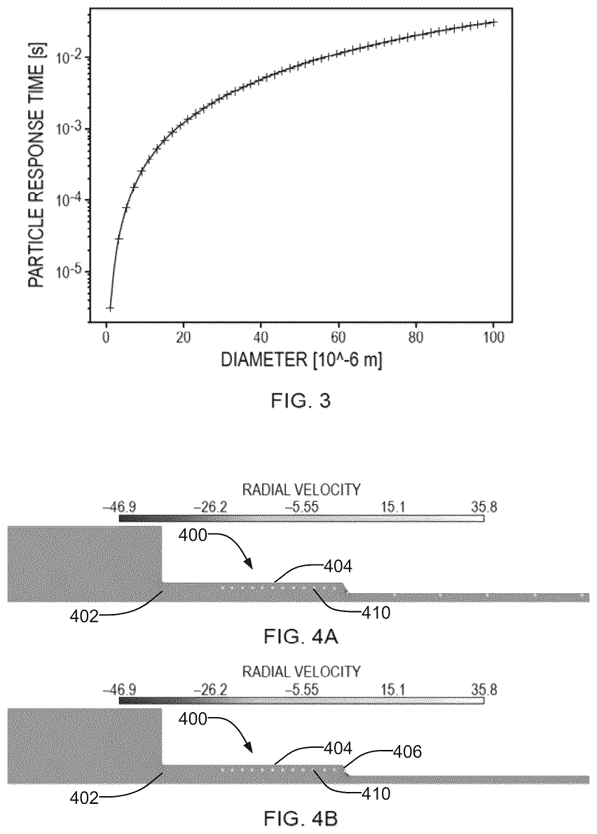

The dynamics of droplets transported in a gas flow are determined by the so-called particle response time tp. This is the time scale over which the droplet velocity reduces to the surrounding gas velocity (exponential decay). Small τₚ means that the droplets follow the gas flow instantaneously, while large τₚ means that they hardly feel the surrounding gas. Assuming water droplets in air gives the relationship between τₚ and droplet diameter shown in FIG. 3. From this relationship, it can be determined that to separate droplets of diameter of about 1 μm or more from a gas flow, droplets down to τₚ˜ 1×10⁻⁵ s need to be separated from the gas flow.

### Flow Basic Considerations

The gas flow through a capillary is a special case. It is a choked flow, meaning that the flow reaches Mach number Ma=1 at the smallest cross section and cannot be accelerated further by reducing the downstream pressure. Basically, the reduced downstream pressure information cannot influence the flow as it is unable to propagate against the supersonic flow into the capillary. The effective flow cross section is the cross section of a streamline, mainly given by the capillary shape, with a correction for the boundary layer. This correction is significant, as due to the small dimensions of the capillary, the boundary layer is relatively thick.

To keep the flow conditions similar to those of a standard capillary, the same cross section at the outlet end of the capillary was chosen. Then, different widenings at the inlet end of the capillary, and/or changes to the straight walls (e.g. by wire erosion) were considered. These inlet modifications were selected in order to cause droplets down to τₚ≈1×10⁻⁵ to be separated from the gas flow.

An example is given in FIGS. 4A-4B, in which a capillary 400 is provided with an increased diameter section 404 at the inlet end 402. FIGS. 4A-4B are stroboscopic pictures of a simulated droplet 410 travelling through the capillary with each dot being separated in time by dt=1×10⁻⁵. FIG. 4A shows the situation with τₚ=0, and FIG. 4B shows the situation with a finite τₚ. As shown in FIG. 4A, for a zero-particle response time, the droplet would follow the gas flow as its direction is turned by the reduction in cross section. However, as shown in FIG. 4B, for a non-zero particle response time, inertia causes the droplet to be transported to the wall 406 when the gas flow direction is turned by the reduction in cross section. Thus, the increased diameter section at the inlet end of the capillary effectively acts as a deposition region, where droplets from the electrospray are preferentially deposited.

To get a more quantitative view, one can determine a time scale of the (steady) flow. The dimensions suggest a time scale of the flow of

$${τ}_{f} = \frac{Δ x}{Δ u} ,$$

with a flow velocity u. So, the inverse derivative (e.g. in the flow direction) is the time scale of a change of a following droplet. From this, one can form the dimensionless number of this problem, the

$$StokesNumber = \frac{τ \_p}{τ \_f} .$$

This indicates if inertial effects play a role or if the droplets follow the gas flow perfectly.

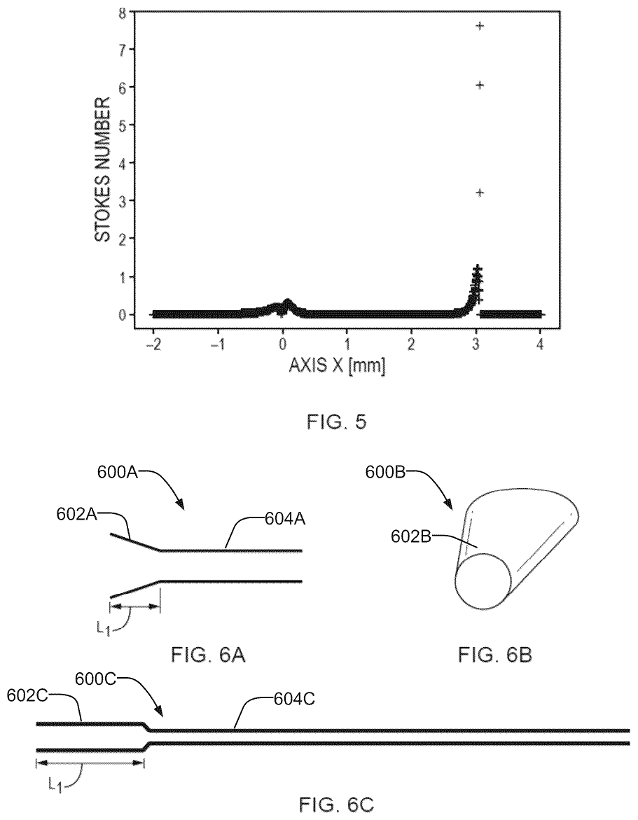

FIG. 5 shows the calculated Stokes number as a function of distance (z) along the capillary. It can be seen that the calculated Stokes number is relatively low along most of the length of the capillary, meaning that droplets will remain entrained in the gas flow. At the entrance of the capillary and at the cross section jump, inertia becomes important (for τₚ=1×10⁻⁵), i.e. the Stokes number approaches or exceeds about 1, meaning that inertia will cause larger droplets to leave the gas flow. This is, of course, only an estimate of the scale-inertial effects exist for the relevant cases of the problem.

The above considerations gave rise to the following initial investigations, in which gas flow simulations were performed for the following capillary geometries:
Reference capillary (“ref523”): a straight capillary with a length L=58.42, and a circular cross section with inner diameter D=0.35;
A capillary with a section at the inlet end having a reducing inner diameter (“capV”): a straight capillary with a length L=58.42, and a circular cross section with a linear reduction in the inner diameter from D₁=0.7 to D₂=0.35 over a distance L₁=3 at the inlet end;
An ellipsoidal to round geometry (“ellips2round”): a straight capillary with a length L=58.42, and a circular cross section for most part, with a section at the inlet end having a cross section that changes from an ellipse with maximum inner diameter D₁=0.7 to a circle with inner diameter D₂=0.35 over a distance L₁=6;
A capillary with an increased diameter section at the inlet end (“drill3”): a straight capillary with a length L=58.42, and a circular cross section with an inner diameter of D₂=0.35 for the most part except for a section at the inlet end having an inner diameter of D₁=0.7 over a distance L₁=3;
A capillary with an increased diameter section at the inlet end (“drill6”): a straight capillary with a length L=58.42, and a circular cross section with an inner diameter of D₂=0.35 for the most part except for a section at the inlet end having an inner diameter of D₁=0.7 over a distance L₁=6; and
A capillary with an increased diameter section at the inlet end (“drill6-10”): a straight capillary with a length L=58.42, and a circular cross section with an inner diameter of D₂=0.35 for the most part except for a section at the inlet end having an inner diameter of D₁=1.0 over a distance L₁=6.

FIG. 6A illustrates schematically a capillary 600A with the “capV” geometry. The capillary 600A has an inlet end 602A with a reducing inner diameter and a straight capillary 604A. FIG. 6B illustrates schematically the inlet end 602B of a capillary 600B with the “ellips2round” geometry. FIG. 6C illustrates schematically a capillary 600C with the “drill” geometries. The capillary 600C has an increased diameter section at an inlet end 602C and a straight capillary 604C. The “capV” and “ellips2round” geometries can be produced using wire erosion techniques, while the “drill” geometries can be produced, for example, by drilling into a standard capillary.

All gas flow simulations were performed assuming a wall temperature of T=523K, with a pressure of 1 atm (101.3 kPa) at the inlet end of the capillary, and a sufficiently low pressure downstream of the capillary (the exact value of the downstream pressure is not important for a choked flow).

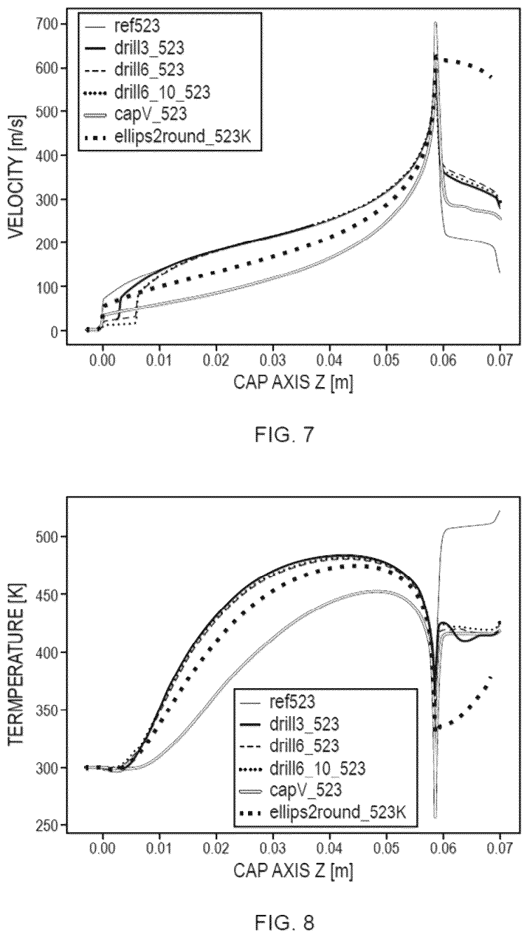

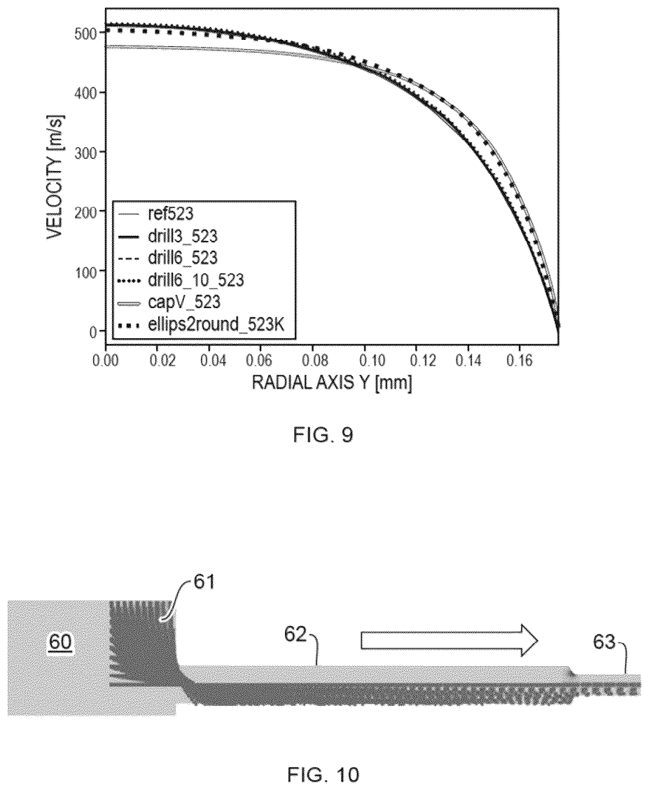

For each of the six exemplary capillary geometries introduced above, FIG. 7 shows the simulated gas velocity as a function of distance (z) along the capillary, FIG. 8 shows the simulated gas temperature as a function of distance (z) along the capillary, and FIG. 9 shows the simulated gas velocity as a function of radial distance (y) within the capillary.

It is desirable for the flow to be close to that of the reference capillary (“ref523”). It was found that all modifications to the inlet end of the capillary produce a very similar outflow of the capillary (at z˜0.06 m). The two capillaries with the continuous cross section reductions (“capV” and “ellips2round”) were surprisingly different and had a much higher mass flow rate (not visible from the plot). This could be traced back to a smaller boundary layer (due to a different pressure gradient) increasing the effective cross section. The flow profile strongly suggests an unchanged flow in the rough vacuum chamber for all modifications purely at the inlet.

From this first round of simulations, it was concluded that all simulated modifications to the inlet end of the capillary were rather similar, and that this freedom could be used to optimise droplet separation. The “capV” and “ellips2round” designs were excluded from further simulations.

### Droplet Separation Study

Further simulations were performed for the “drill” geometry to ensure that droplets will be transported to the wall in the designated deposition area at the inlet end of the capillary.

FIG. 10 illustrates these simulations, where a cloud of droplets 61 is represented by a pattern of initial droplet locations in the atmospheric pressure spray region 60 of the ion source 10. As shown in FIG. 10, the capillary has a larger diameter section 62 at its inlet end followed by a “normal” diameter section 63 (only partially shown in FIG. 10). The droplets are modelled as point particles, driven by the gas flow (which moves in the direction shown by the arrow). The only variable parameter is the particle response time which encodes the droplet size. Different weightings of the initial location and different initial velocity conditions were tested, and the results were largely insensitive to it.

It was found that large droplets (i.e. droplets with large response times) are separated from the gas flow, i.e. they are not transmitted beyond the wider part 62 of the capillary.

Various different configurations of the “drill” geometry were tested. Variations were made to the length (L₁) of the larger diameter section 62 (e.g. the drill depth), the inner diameter of the larger diameter section 62 (e.g. the drill diameter), the shape of chamfer at the corner between the atmospheric pressure spray region 60 and the larger diameter section 62, and the shape of chamfer at the corner between the larger diameter section 62 and the normal section 63 (e.g. the drill tip angle). It was also checked that different drill tip angles would not negatively affect the droplet separation.

Table 1 summarises the properties of the various simulated designs.

TABLE 1

| | Drill | Drill | Further | |
|---|---|---|---|---|
| | depth | diameter | modifi- | |
| Design | (L₁) | (D₁) | cation(s) | Comments |
| drill3_SmoothInlet | 3 | .7 | Funnel like | |
| | | | smoothed inlet | |
| drill3_DrillInlet | 3 | .7 | Funnel like | |
| | | | inlet by drill | |
| | | | .25 mm depth | |
| | | | 118 deg | |
| drill6_10 | 6 | 1.0 | | |
| drill3 | 3 | .7 | | |
| drill_6_140Deg | 6 | .7 | Drill angle 140, | Angle of small |
| | | | otherwise 118 | diameter drills, |
| | | | | no substantial |
| | | | | change due |
| | | | | to it |
| drill6 | 6 | .7 | | |
| drill_8 | 8 | .7 | | |
| drill_6_06 | 6 | .6 | | Final tuning |
| drill_6_055 | 6 | .55 | | Final tuning |
| ellips2round | | | Linear change | Too much |
| | | | from elliptical | change to |
| | | | to round cross | flow rate |
| | | | section | |
| V Capillary | | | Linear change | Too much |
| | | | from .7 to .35 | change to |
| | | | diameter, | flow rate, |
| | | | always round | too little |
| | | | | heating |

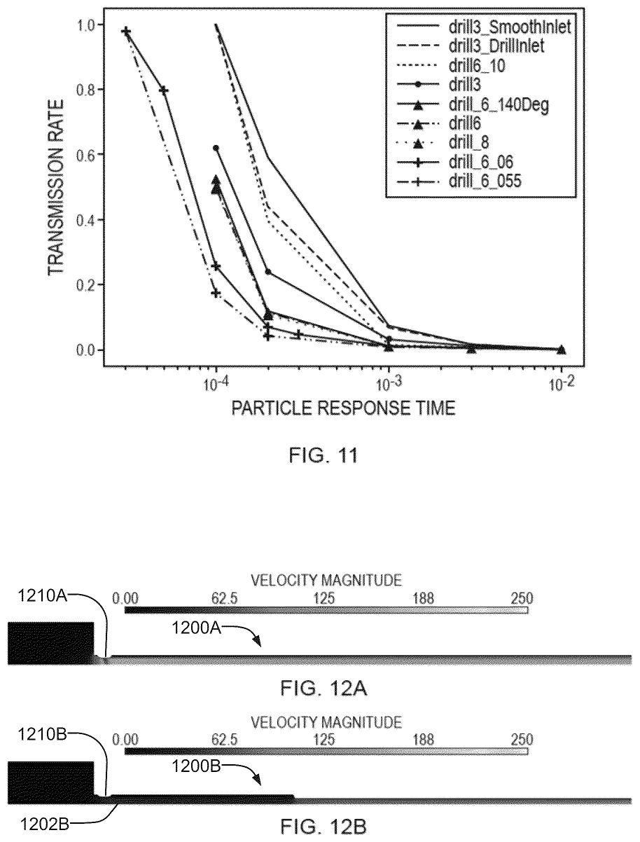

FIG. 11 shows the simulated transmission rate as a function of the particle response time, where a low transmission rate is a successful separation. A drill length of 6 mm with a diameter of 0.55 or 0.6 mm was found to be the best in the simulated set. Even though the 0.55 mm diameter design was slightly better, the 0.6 mm diameter design was selected to allow some extra space for deposition. It was anyway unclear if this difference could be accurately reproduced in practice by the tolerances achievable during mechanical production.

The drill tip angle can be changed without influence for typical angles of drills. It can be flat (180 degrees) or even more than 180 degrees.

### Droplet Deposition

To investigate the effect of deposition build-up, a small round hill was included in the simulations. Of course, this can give only a basic understanding as the exact structure of the build-up is unknown. FIG. 12A shows such a simplified build-up 1210A in an unmodified capillary 1200A, while FIG. 12B shows a simplified build-up 1210B in capillary 1200B having an enlarged cross section at the inlet end 1202B.

As can be seen from FIG. 12A, due to the choked flow, the flow velocity for the unmodified capillary is already close to sonic. This implies a strong impact on the flow velocity of a relatively small deposition, as the deposition will create a new choking condition. In contrast, as can be seen from FIG. 12B, the flow velocity is much smaller for the modified capillary due to the larger cross section, which implies a much-improved resilience to deposition of dirt.

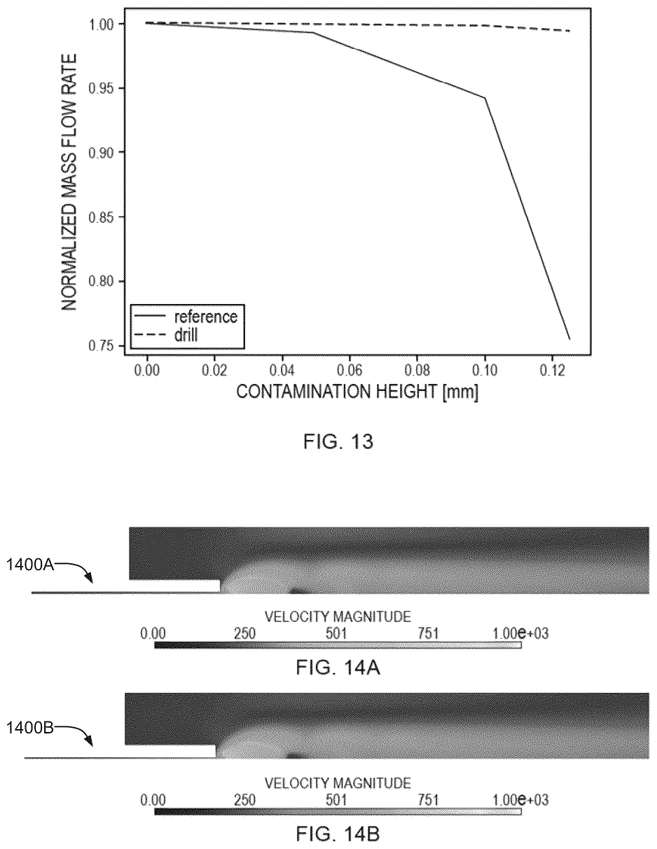

FIG. 13 shows simulated mass flow rate as a function of the height of the contamination. It can be seen that, in the case of the modified capillary, a much higher build up is required before a change in the mass flow rate, and thereby the ion transmission, is observed. Furthermore, the same height is associated with a much bigger deposit volume, due to the larger radius in the modified geometry. This data implies a significant increase in the lifetime of the capillary, of around a factor of 4-8, is achievable-which was also found in experiment.

In these simulations, it is assumed that the dirt is deposited at the droplet impact location. This could be invalidated by splashing, i.e. the breakup of an impinging droplet into smaller satellite droplets. The degree of splashing can be estimated by the splashing number, constructed from the Weber number (We) and the Reynolds number (Re): We^{1/2}*Re^{1/4}<50. This was tested with the values from the droplet simulation, and it was found that splashing is not expected.

### Validation of Flow in Rough Vacuum Chamber

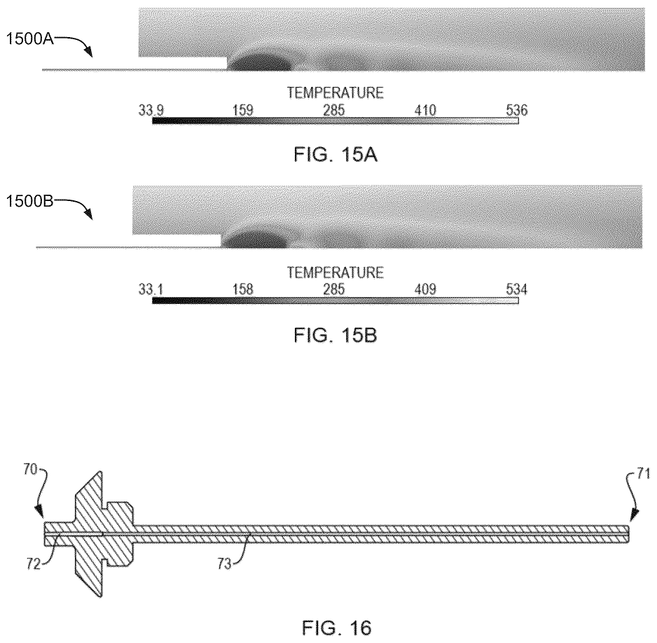

While the flow structure in the modified capillary strongly implies an unchanged jet into the rough vacuum, this was nonetheless tested by simulations. FIG. 14A shows the velocity profile in the case of an unmodified capillary 1400A, while FIG. 14B shows the velocity profile in the case of a capillary 1400B with a widened inlet section. FIG. 15A shows the temperature profile in the case of an unmodified capillary 1500A, while FIG. 15B shows the temperature profile in the case of a capillary 1500B with a widened inlet section.

When comparing the velocity and temperature plots of FIGS. 14A-14B and 15A-15B, only a very small variation is visible between the unmodified capillaries 1400A/1500A and the capillaries 1400B/1500B with a widened inlet section. This is likely due to the (very small) difference in heat transfer between the capillaries.

### Construction

FIG. 16 shows schematically a final design of an atmospheric pressure inlet in accordance with an embodiment.

The capillary geometry is modified to allow more space for contamination at the inlet end, to ensure deposition of contamination in this designated area, to keep the flow conditions similar to previous (proven) designs, and to allow for simple production. Specifically, the geometrical change comprises a widening at the atmospheric side by a straight bore hole. The depth and width of the bore hole were optimized numerically to enable transport of droplets of relevant range of diameters to the walls of this wider part of the capillary.

Thus, as shown in FIG. 16, the atmospheric pressure inlet comprises a transfer tube having an upstream (inlet) end 70 and a downstream (outlet) end 71, configured to transfer ions together with a gas flow from the upstream end 70 to the downstream end 71. The transfer tube has a total length of 58.42 mm, is straight and has a circular cross section. For most of its length 73, the capillary has an inner diameter of 0.35 mm. A modified section 72 at the inlet end, with a length of 6 mm, has a larger diameter of 0.6 mm. This modified region 72 is in the form of a simple drill hole.

The modified region 72 acts as a deposition region. The change in diameter between the modified region 72 and the remainder of the capillary 73 creates a turn in the gas flow, and the effect of this is that most or all relatively large particles (τₚ≥1×10⁻⁵) entrained in the gas flow are deposited in the deposition region 72 while most or all relatively small particles (τₚ<1×10⁻⁵) (such as ions) entrained in the gas flow remain entrained in the gas flow and are transported beyond the deposition region 72 towards the downstream end of the transfer tube 71.

Thus, the transfer capillary includes an area in which dirt is preferentially deposited. This design offers higher robustness to contamination build-up and thereby prolongs the service intervals of the mass spectrometer. The capillary can also reduce contamination of the other parts of the mass spectrometer downstream of the inlet.

The modified capillary of FIG. 16 was tested in comparison with an unmodified capillary by spraying a strongly polluting substance (ubiquitin) and monitoring the fore-vacuum pressure and the ion count. A substantial increase in the lifetime was found, as a sufficient ion count was found over a much longer interval.

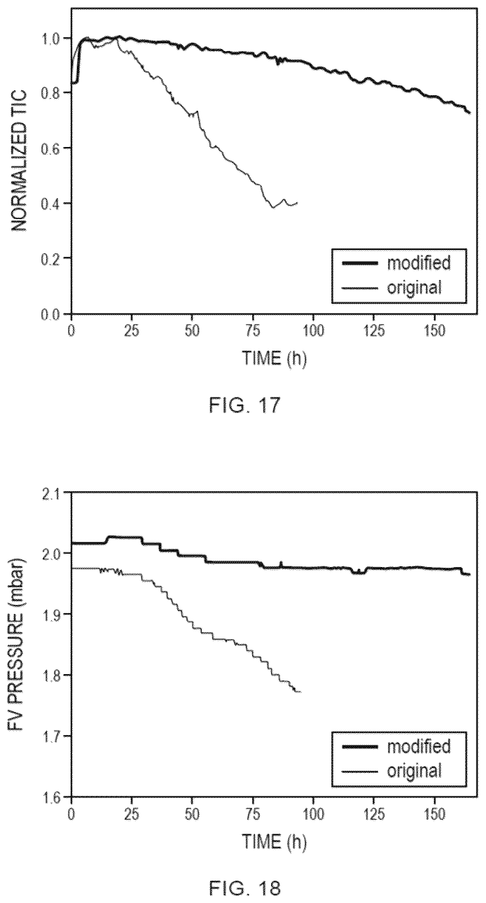

FIG. 17 shows experimental data illustrating the decline in the total ion current signal over time when infusing ubiquitin for the reference and the modified capillaries. It can be seen that the performance decline for the modified capillary is much slower than for the reference capillary.

FIG. 18 shows experimental data illustrating the decline of the fore-vacuum pressure over time when injecting ubiquitin for the reference and the modified capillaries. It can again be seen that the modified capillary clogs much slower than the reference capillary.

It will be appreciated that embodiments provide a contamination robust capillary by inertia driven dirt separation and deposition. The capillary has a designated contamination region providing high contamination tolerance with only small modifications to the outflow. A turn in the gas flow due to a change in cross section causes dirt to be separated from the gas flow by inertial effects. This results in good separation of dirt in the designated contamination region. Deposition of material is concentrated in the contamination region which can accommodate much more material than the conduit to vacuum. The location of the deposition is more easily accessible and easier to clean, particularly for mechanical cleaning. The modification is simple and cheap to produce.

The modified capillary allows longer service intervals, e.g. for applications with strong contamination. That is, it allows instruments to be run for longer without requiring service, e.g. from trained service personnel.

Embodiments can be implemented on existing instruments without additional modifications and can be combined with existing strategies to reduce contamination. For example, the ESI sprayer can be oriented at an angle or can be arranged off-axis relative to the vacuum inlet, and/or additional gas flows can be provided to remove droplets such as a sweep gas, curtain gas or counter gas flow.

Although preferred embodiments have been described above, several variations are possible.

Various different geometrical modifications can be made. For example, the widened part and/or the main capillary need not be straight but could instead be non-straight. The widened part and/or the main capillary need not have a round cross section but could instead (in part or wholly) have a non-round cross-section (e.g. a letter box or polygon shape). The widened part need not be on-axis with the main capillary but could instead be off-axis. The widened part need not be parallel with the main capillary but could instead be provided at an angle.

The widened part need not be created by drilling but could be created in several different ways, e.g. by one or more washers with different diameters, one or more pockets, and/or one or more separate front parts arranged in front of a standard capillary.

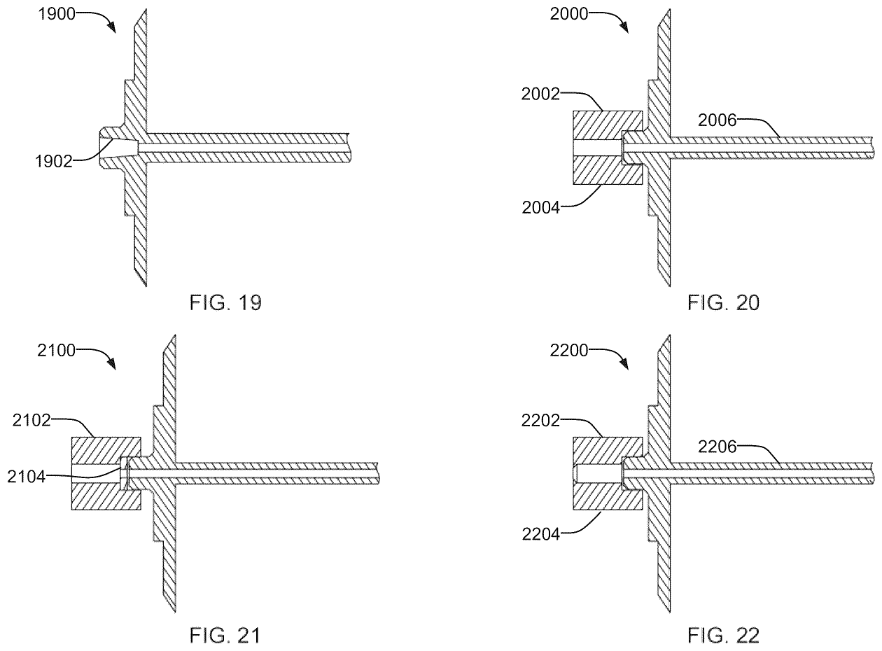

FIG. 19 shows a capillary 1900 configured in accordance with an embodiment in which the widened part 1902 is in the form of a truncated conical hole. Such a hole can be produced by erosion.

FIG. 20 shows a capillary 2000 configured in accordance with an embodiment in which the widened part 2002 is created by an additional part 2004 arranged in front of a standard capillary 2006. The additional part provides a similar shape to the drilled hole and provides a similar dirt separation effect.

FIG. 21 shows a capillary 2100 configured in accordance with an embodiment in which multiple parts 2102, 2104 are used to create a similar shape to the drilled hole. Variations in the shape of the widened part can also be created by multiple parts.

FIG. 22 shows a capillary 2200 configured in accordance with an embodiment in which the widened part 2202 is again created by an additional part 2204 arranged in front of a standard capillary 2206. In this embodiment, a more complex shape is provided (namely, a reduction in cross section at the inlet) which would not be possible by simple drilling.

The shape of the deposition region can be varied. The deposition region can have any cross-sectional shape, such as an ellipse, a polygon, a rounded polygon, etc.

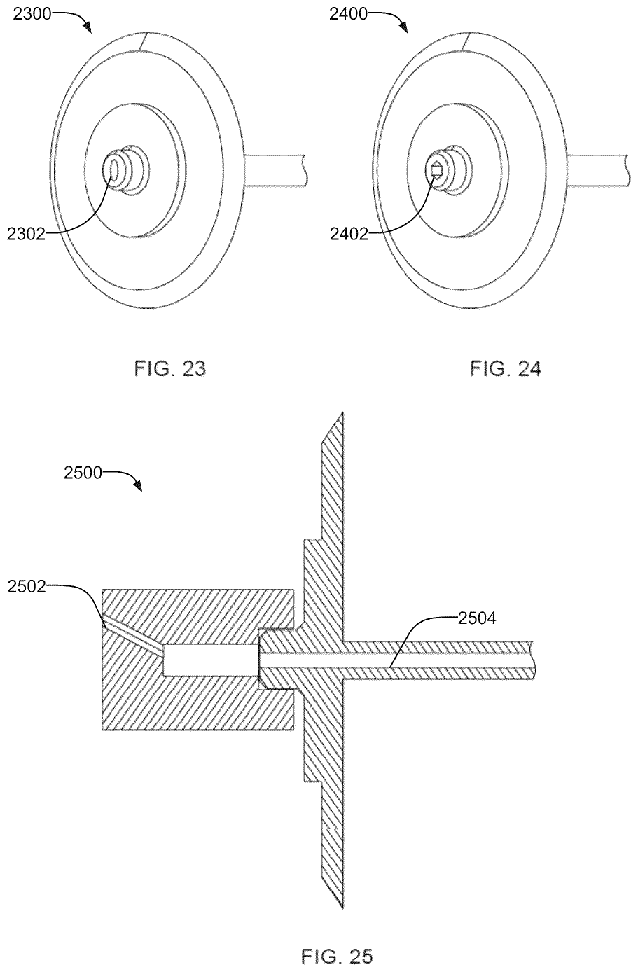

FIG. 23 shows a capillary 2300 configured in accordance with an embodiment having a non-round “letterbox” front widening 2302, and FIG. 24 shows a capillary 2400 configured in accordance with an embodiment having a non-round polygonal front widening 2402. These widenings can be created by using electric erosion with a non-round tool instead of a drill.

FIG. 25 shows a capillary 2500 configured in accordance with an embodiment in which an additional canal 2502 is provided at an angle, not necessary on the same plane as the main capillary 2504, to provide additional dirt separation.

Although the present invention has been described with reference to various embodiments, it will be understood that various changes may be made without departing from the scope of the invention as set out in the accompanying claims.

1. An inlet for an analytical instrument, the inlet comprising:
a transfer tube having an upstream end and a downstream end, wherein the transfer tube is configured to transfer ions together with a gas flow from the upstream end to the downstream end; and
a deposition region arranged at or adjacent to the upstream end of the transfer tube,
wherein the transfer tube and the deposition region are configured such that the gas flow experiences at least one turn in the deposition region, whereupon relatively large particles entrained in the gas flow are deposited in the deposition region while relatively small particles entrained in the gas flow remain entrained in the gas flow and are transported beyond the deposition region towards the downstream end of the transfer tube, and
wherein the at least one turn in the gas flow is created by: a change in cross-sectional area of the gas flow in the deposition region, a change in diameter of the gas flow in the deposition region, and/or a change in cross-sectional shape of the gas flow in the deposition region.

2. The inlet of claim 1, wherein:
the relatively large particles are particles that have diameters greater than or equal to a first particle diameter; and
the at least one turn in the gas flow is configured such that the Stokes number for particles having the first particle diameter becomes greater than or equal to 0.5 at the least one turn.

3. The inlet of claim 2, wherein the at least one turn in the gas flow is configured such that the Stokes number for particles having the first particle diameter becomes greater than or equal to 1 at the least one turn.

4. The inlet of claim 2, wherein the transfer tube and the deposition region are configured such that the Stokes number for particles having the first particle diameter is less than 0.5 downstream of the deposition region.

5. The inlet of claim 1, wherein:
the deposition region extends from an upstream end of the deposition region to a downstream end of the deposition region; and
the transfer tube and the deposition region are configured such that at least one line-of-sight exists between the upstream end of the deposition region and the transfer tube.

6. The inlet of claim 1, wherein:
the transfer tube has a main central axis extending from its upstream end;
the deposition region comprises a straight tube having a central axis extending from an upstream end of the deposition region to a downstream end of the deposition region;
the downstream end of the deposition region is immediately adjacent to the upstream end of the transfer tube; and
the transfer tube and the deposition region are configured such that the second central axis is arranged at an angle≤10° relative to the main central axis and/or such that there is at least some degree of overlap between the cross-sections of the transfer tube and the deposition region.

7. The inlet of claim 1, wherein:
the at least one turn in the gas flow is created by a change in cross-sectional area of the gas flow in the deposition region; and
the deposition region has a first cross-sectional area upstream of the at least one turn, and the transfer tube has a second cross-sectional area downstream of the at least one turn, wherein the first cross-sectional area is greater than the second cross-sectional area.

8. The inlet of claim 7, wherein the first cross-sectional area is 2 or more times greater than the second cross-sectional area.

9. The inlet of claim 1, wherein a length of the transfer tube is 5 or more times greater than a length of the deposition region.

10. The inlet of claim 1, wherein the deposition region is part of the transfer tube.

11. The inlet of claim 10, wherein the deposition region comprises a bore hole in the upstream end of the transfer tube.

12. The inlet of claim 1, wherein the deposition region is formed from a device arranged adjacent to the upstream end of the transfer tube.

13. The inlet of claim 1, wherein the transfer tube and the deposition region are configured such that most or all relatively large particles entrained in the gas flow are deposited in the deposition region while most or all relatively small particles entrained in the gas flow remain entrained in the gas flow and are transported beyond the deposition region towards the downstream end of the transfer tube.

14. The inlet of claim 1, wherein:
the relatively large particles are particles that have diameters greater than or equal to a first particle diameter, wherein the first particle diameter is between 0.1 μm and 5 μm; and
the relatively small particles are particles that have diameters less than a second particle diameter, wherein the second particle diameter is less than or equal to the first particle diameter, wherein the second particle diameter is between 0.1 μm and 5 μm.

15. An analytical instrument comprising:
an ionisation region;
a fore vacuum chamber; and
the inlet of claim 1, wherein the instrument is configured such that ions generated in the ionisation region can be transported to the fore vacuum chamber via the inlet.

16. The instrument of claim 15, further comprising an ion source arranged in the ionisation region,
wherein the relatively large particles are droplets produced by the ion source that have diameters greater than or equal to a first particle diameter, and
wherein the relatively small particles are ions and droplets produced by the ion source that have diameters less than a second particle diameter, wherein the second particle diameter is less than or equal to the first particle diameter.

17. The instrument of claim 15, comprising an Electrospray Ionisation (ESI) ion source arranged in the ionisation region.

18. The instrument of claim 15, further comprising:
a mass analyser; and
one or more ion guides arranged in or downstream of the fore vacuum chamber and configured to transport ions from the downstream end of the transfer tube to or towards the mass analyser.

19. A method of operating an analytical instrument that comprises an inlet comprising a transfer tube having an upstream end and a downstream end, and a deposition region arranged at or adjacent to the upstream end of the transfer tube, the method comprising:
transferring ions together with a gas flow from the upstream end of the transfer tube to the downstream end of the transfer tube, wherein the transfer tube and the deposition region are configured such that the gas flow experiences at least one turn in the deposition region whereupon relatively large particles entrained in the gas flow are deposited in the deposition region while relatively small particles entrained in the gas flow remain entrained in the gas flow and are transported beyond the deposition region towards the downstream end of the transfer tube,
wherein the at least one turn in the gas flow is created by: a change in cross-sectional area of the gas flow in the deposition region, a change in diameter of the gas flow in the deposition region, and/or a change in cross-sectional shape of the gas flow in the deposition region.

20. A method of manufacturing an inlet for an analytical instrument, the method comprising:
providing a transfer tube having an upstream end and a downstream end, wherein the transfer tube is configured to transfer ions together with a gas flow from the upstream end to the downstream end, and wherein the transfer tube has a second cross-sectional area, a second inner diameter, and/or a second cross-sectional shape; and
creating a deposition region at or adjacent to the upstream end of the transfer tube by:
(i) forming a hole in the upstream end of the transfer tube; or
(ii) attaching a device having a hole adjacent to the upstream end of the transfer tube,
wherein the hole has a first cross-sectional area that is different to the second cross-sectional area, a first inner diameter that is different to the second inner diameter, and/or a first cross-sectional shape that is different to the second cross-sectional shape.
